(19) United States
(12) Patent Application Publication
(10) Pub. No.: US 2015/0305395 A9
(43) Pub. Date: Oct. 29, 2015

(54) METHOD OF INSTANTIZING AMINO ACIDS

(71) Applicant: Milk Specialties Company d/b/a/ Milk Specialties Global, Eden Prairie, MN (US)

(72) Inventor: Suvash Kafley, Eden Prairie, MN (US)

(21) Appl. No.: 14/372,959

(22) PCT Filed: Jan. 18, 2013
(86) PCT No.: PCT/US13/22111

§ 371 Date: Jul. 17, 2014

Related U.S. Application Data
(60) Provisional application No. 61/588,857, filed on Jan. 20, 2012.

(51) Int. Cl. A23L 2/66; A23L 1/00; A23L 1/305

(52) U.S. Cl. CPC A23L 2/66; A23L 1/3051; A23L 1/0017; A23V 2002/00

(57) ABSTRACT

This disclosure describes a process for producing an instantized amino acid product and compositions including such instantized amino acid products. Generally, the process includes obtaining a particulate amino acid, coating the amino acid particles with an aqueous solution of a food grade gum, adhering two or more gum-coated amino acid particles to another to form an agglomerate of amino acid particles, drying the agglomerate, coating the agglomerate with an aqueous solution of a food grade surfactant, and drying the surfactant-coated agglomerate. In another aspect the process generally includes obtaining amino acid particles, coating the amino acid particles with an aqueous solution of a food grade surfactant, and drying the surfactant-coated amino acid particles. This disclosure also describes amino acid particles and agglomerates of amino acid particles.

### CROSS-REFERENCE TO RELATED APPLICATION

This application claims priority to U.S. Provisional Patent Application Ser. No. 61/588,857, filed Jan. 20, 2012, which is incorporated herein by reference.

### BACKGROUND

Amino acids are organic acids containing both a basic amino group (—NH₂) and an acidic carboxyl group (—COOH), thus they are amphoteric and exist in aqueous solutions as dipolar ions. There are many different amino acids. The 25 amino acids that have been established as protein constituents are alpha-amino acids (that is the —NH₂ group is attached to the carbon atom next to the —COOH group). Many other amino acids occur in the free state in plant or animal tissue. Amino acids can be obtained by hydrolysis of a protein, or they may be synthesized in various ways, especially by fermentation of glucose. An essential amino acid is one which cannot be synthesized by the body and is necessary for survival. The essential amino acids include isoleucine phenylalanine, leucine, lysine, methionine, threonine, tryptophan, and valine. Nonessential amino acids, such as alanine, glycine, and about 12 others can be synthesized by the body in adequate quantities. The amino acids of arginine and histidine are essential during periods of intense growth. The general term “amino acid” as used herein is intended to include essential and nonessential as well as natural and synthetically-derived amino acids.

Amino acids are typically added to various liquids to enhance the nutritional value of the liquid, or they are combined with other dry ingredients to be added to liquid at a future time. The liquids are normally used as food products for humans or animals. Typical food products having amino acids added include, but are not limited to, water, milk, infant formula, a sport drink, an energy drink, coffee, tea, fruit juice, protein shakes, and/or meal-replacement beverages. To result in a satisfactory end product, the amino acids should disperse quickly and either dissolve, disperse, or solubilize in cold or warm liquid. Many amino acids are provided by their supplier in the physical form of flakes, crystals, or powders. These particles tend to float on the surface of the liquid and reluctant to sink and dissolve, disperse, or solubilize in the liquid.

### SUMMARY

In one aspect, this disclosure describes a process for producing an instantized amino acid product. Generally, the process includes obtaining a particulate amino acid, coating the amino acid particles with an aqueous solution of a food grade gum, adhering two or more gum-coated amino acid particles to another to form an agglomerate of amino acid particles, drying the agglomerate, coating the agglomerate with an aqueous solution of a food grade surfactant, and drying the surfactant-coated agglomerate.

In some embodiments, the process can include using a particulate amino acid having a particle size of from 63 microns (230 mesh) to 400 microns (40 mesh). In some of these embodiments, the particulate amino acid can have a particle size of from 100 microns to 200 microns.

Coating the amino acid particles with an aqueous solution of a food grade gum can result in gum-coated amino acid particles adhering to one another to form an agglomerate. This may be achieved by partially coating or completely coating the amino acid particles with the aqueous solution of a food grade gum.

In some embodiments, drying the gum-coated amino acid particles can cause the gum to shrink, thereby creating open porous channels in the gum layer between individual amino acid particles.

In some embodiments, the surfactant used to coat the agglomerates can reduce the surface tension of the agglomerate when combined with a liquid.

The above steps of drying (gum and surfactant) and of forming the agglomerates can be performed by various techniques. In some embodiments, one or both drying steps may be performed in a fluid bed apparatus with warm air entering from the bottom of the fluid bed. In some embodiments, the temperature of the air may be from 140° F. to 212° F.

In another aspect, this disclosure describes a surfactant-coated agglomerate of amino acid particles.

In another aspect, this disclosure describes a process for producing an instantized amino acid product. Generally, this method includes obtaining amino acid particles, coating the amino acid particles with an aqueous solution of a food grade surfactant, and drying the surfactant-coated amino acid particles.

In some embodiments, the process may be performed using amino acid particles of from 150 microns (100 mesh) to 400 microns (40 mesh).

In some embodiments, coating the particles with surfactant and drying the coated particles may be performed in a fluid bed operation.

In another aspect, this disclosure describes surfactant-coated amino acid particles.

In another aspect, this disclosure describes an amino acid-enriched liquid formed by adding amino acid agglomerates as described herein to a liquid. In some embodiments, the amino acid-enriched liquid can include from one gram of amino acid per 100 milliliters of liquid to 10 grams of amino acid per in 100 milliliters of liquid.

In another aspect, this disclosure describes an amino acid-enriched liquid formed by adding surfactant-coated amino acid particles as described herein to a liquid. In some embodiments, the amino acid-enriched liquid can include from one gram of amino acid per 100 milliliters of liquid to 10 grams of amino acid per in 100 milliliters of liquid.

### DETAILED DESCRIPTION OF ILLUSTRATIVE EMBODIMENTS

Instantized products are products in particulate or powder form that are often added to a liquid before the liquid is ultimately used. An end user often prefers that an instantized product readily combines with a liquid—i.e., as little of the instantized product as possible floats at the surface of the liquid or sinks to the bottom of the container holding the liquid.

This disclosure relates to instantized amino acid products and methods for their manufacture. Amino acids typically have a specific gravity greater than that of common liquids to which the amino acids are added such as, for example, water and milk. Although their specific gravity may be greater than the liquid, amino acids can tend to float at the surface of the liquid due at least in part to the shape of the amino acid particles and/or surface tension of the liquid. This disclosure describes two different processes for producing instantized amino acid products that possess improved solubility and/or dispersibility in a liquid, the instantized amino acid products produced by each process, and liquid compositions that include at least one of the instantized amino acid products.

One process involves making an agglomerate of amino acid particles. Generally, the process includes obtaining a particulate amino acid, coating the amino acid particles with an aqueous solution of a food grade gum, adhering multiple gum-coated amino acid particles together to form an agglomerate of amino acid particles, drying the agglomerate, coating the agglomerate with an aqueous solution of a food grade surfactant, and drying the surfactant-coated agglomerate.

The amino acid particles may have a particle size of from 63 microns (230 mesh) to 400 microns (40 mesh), although in certain embodiments the process may be performed using amino acid particles outside of this size range. In certain embodiments, the amino acid particles can have a size of from 100 microns to 200 microns. The amino acid particles can be obtained from a commercial supplier having the desired particle size or they may be obtained in a larger particle size and the particle size reduced. The particle size can be reduced by grinding or milling such as, for example, hammer milling or jet milling.

The amino acid particles can include one amino acid or a mixture of two or more amino acids. Exemplary amino acids that may be used in the process include hydrophobic amino acids such as, for example, leucine, isoleucine, valine, methionine, tryptophan, cysteine, alanine, tyrosine, phenylalanine, histidine, threonine, serine, and/or proline. In some embodiments, the process can use one or more branched chain essential amino acids such as, for example, leucine, isoleucine, and/or valine.

The amino acid particles may be coated with an aqueous solution of a food grade gum. Any food grade gum, or any combination of more than one food grade gum, can be used. In some embodiments, the food grade gum can include guar gum, xanthan gum, tara gum, gum arabic, lambda carrageenan, konjac, sodium alginate, cellulose gel, and cellulose gum.

The food grade gum may be placed into an aqueous solution to hydrate the gum. The concentration of the gum solution can vary depending on the type of gum used. The concentration of the gum in the aqueous solution can be from 2%, by weight, to 15%, by weight, of the aqueous solution, although the process can be performed using an aqueous solution having a concentration of food grade gum outside of this range. In some embodiments, the concentration of gum in the aqueous solution can be, for example, 2%, by weight; 3%, by weight; 4%, by weight; 5%, by weight; 6%, by weight; 7%, by weight; 8%, by weight; 9%, by weight; 10%, by weight; 11%, by weight; 12%, by weight; 13%, by weight; 14%, by weight; or 15%, by weight. In other embodiments, the concentration of gum in the aqueous solution may be a range having endpoints defined by a first gum concentration listed above and a second gum concentration that is different than the first gum concentration. For example, the concentration of gum in the aqueous solution may be from 2%, by weight, to 10%, by weight. In one exemplary embodiment, the aqueous solution of food grade gum can include 15%, by weight, guar gum.

The amino acid particle may be partially or completely coated by the food grade gum. The aqueous solution containing the gum can be applied to the amino acid particles by any suitable method such as, for example, by spraying in a fluid bed apparatus, then agitating the mixture sufficiently to produce a thorough intermixture. The fluidizing action of a fluid bed can promote agglomerating of the particles. The gum can cause amino acid particles to adhere to one another to form agglomerates in which a gum portion or layer can exist between agglomerated amino acid particles. The number of amino acid particles in an agglomerate can be two or more. The number of amino acid particles in a typical agglomerate can depend, at least in part, on, for example, the original size of the amino acid particles and the desired size of the agglomerates.

The agglomerates may be dried to remove water that was present in the aqueous gum solution. As used herein, the term “dried” refers to the character of having any portion of water that was present in the aqueous gum solution removed and is not intended to convey that 100% of the water is removed. Thus, in some embodiments, at least 50% of the water is removed during the drying process.

The agglomerates may be dried by any suitable method including, for example, in a fluid bed apparatus. In such embodiments, the agglomerates may be dried using heat at a temperature of, for example, from 140° F. to 212° F., although the agglomerates may be dried using heat at temperatures outside this range. The particular temperature to which the agglomerates are heated to may depend, at least in part, on the desired time to be devoted to drying the agglomerates. In certain embodiments, the agglomerates may be dried in heat at a temperature of from 160° F. to 180° F. such as, for example, from 160° F. to 170° F. Heated air may be fed into the bottom of the fluid bed to dry the agglomerates.

Drying the agglomerates can cause the gum to shrink, which can result in open porous channels forming between amino acid particles in an agglomerate. The open porous channels in an agglomerate can allow liquid to enter the agglomerate when the agglomerate is added to a liquid. This can result in the agglomerates entering the liquid faster than if the open porous channels were not present. The open porous channels also may improve gum hydration, agglomeration disassociation, and/or amino acid particle dispersion.

In embodiments in which the agglomerates are formed and dried in the same apparatus—e.g., where the amino acid particles are coated with the aqueous gum solution, agglomerated, and dried in a fluid bed—one or more steps in the process may be performed simultaneously.

The agglomerates may be coated with an aqueous solution of a food grade surfactant. The surfactant can reduce surface tension of the agglomerate with the liquid. This can promote entry of the agglomerate into the liquid and, ultimately, promote dissolution and/or dispersion of the amino acid into the liquid. Any food grade surfactant may be used to coat the agglomerates. Exemplary surfactants include, for example, soy lecithin and/or sunflower lecithin. The aqueous solution of surfactant can contain surfactant in an amount of from 1%, by weight, to 5%, by weight such as, for example, from 2%, by weight to 4%, by weight. Generally, the surfactant may be applied to the surface of the agglomerates in any suitable manner. Exemplary methods include, for example, spraying the surfactant onto dry particles of the agglomerates, then agitating the mixture sufficiently to produce a thorough intermixture. An agglomerate may be partially or completely coated by the food grade surfactant.

The surfactant-coated agglomerates may be dried to reduce the water content resulting from the application of the aqueous surfactant solution. The same drying conditions, processes (e.g., use of a fluid bed), and considerations may be used to dry the surfactant-coated agglomerates as was described above to dry the gum in the agglomerates. The drying creates an agglomerate having an inner core of multiple amino acid particles adhered together with a food grade gum and the core having open porous channels located between the amino acid particles, with an outer layer of food grade surfactant.

The amino acid agglomerates produced as described above may be suitable to form an instantized amino acid product. When added to a liquid such as, for example, water or milk, the agglomerates can create an amino acid-enriched liquid. The agglomerates can begin to enter cross the surface of and enter the liquid in less than 10 seconds such as, for example, less than nine seconds, less than eight seconds, less than seven seconds, less than six, seconds, less than five seconds, less than four seconds, less than three seconds, less than two seconds, or less than one second. As liquid is drawn into the porous open channels in the agglomerate, the gum can break down and release the amino acid particles. The amino acid particles are then free to dissolve and/or disperse in the liquid.

The amount of amino acid, provided in agglomerate form but measured in terms of the mass of amino acid present in the agglomerate, added to the liquid can be from 1 gram of amino acid per 100 milliliters of liquid to 10 grams of amino acid per 200 milliliters of liquid. In certain embodiments, one can add two grams of amino acid per 200 ml of liquid.

The agglomerates described herein can dissolve and/or disperse into a liquid more readily than comparable alternative amino acid preparations. For example, an agglomerate, when combined with distilled water at room temperature and stirred for 20 seconds, can result in a liquid composition that is capable of transmitting more than 50% of light at 520 nm such as, for example, at least 52%, at least 54%, at least 56%, at least 58%, at least 60%, at least 62%, at least 64%, at least 66%, at least 68%, at least 70%, at least 72%, at least 74%, at least 76%, at least 78%, at least 80%, at least 82%, at least 84%, at least 86%, at least 88%, at least 90%, at least 92%, at least 94%, at least 96%, at least 98%, or at least 99% of light at 520 nm.

Also, as another example, an agglomerate as described herein, when combined with water at room temperature and stirred for 20 seconds, can result in a liquid composition in which the amino acid is sufficiently dissolved or dispersed in the liquid so that at least 67% of the amino acid in the liquid composition, by weight, passes through a 20 μm filter (e.g., grade P8 filter paper) such as, for example, at least 68%, at least 69%, at least 70%, at least 71%, at least 72%, at least 73%, at least 74%, at least 75%, at least 76%, at least 77%, at least 78%, at least 79%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, or at least 99% of the amino acid passes through such as filter.

In some embodiments, one or more ingredients may be added to the liquid in addition to the agglomerate. Such other ingredients include, for example, vitamins, minerals, nutritional supplements, sweeteners, thickening agents, and the like.

The second process involves producing an instantized amino acid products by coating amino acid particles with a food grade surfactant. Generally, this method includes obtaining amino acid particles, coating the amino acid particles with an aqueous solution of a food grade surfactant, and drying the surfactant-coated amino acid particles.

In this second process, agglomerates are not formed. This process may be preferred when the amino acid particles are from 150 microns (100 mesh) to 400 microns (40 mesh), although the process may be performed using amino acid particles with sizes outside of this range. In some embodiments, the process may be performed using amino acid particles from 200 microns to 300 microns.

The amino acid particles can be obtained from a commercial supplier having the desired particle size or they may be obtained in a larger particle size and the particle size reduced. The particle size can be reduced by grinding or milling such as, for example, hammer milling or jet milling. If the particle size of the amino acid is smaller than 150 microns, one may prefer but is not necessarily required to agglomerate the amino acid particles using the first process described above.

The amino acid particles may be coated with an aqueous solution of a food grade surfactant. In certain embodiments of this process, one may use a greater concentration of food grade surfactant than would be used to coat a similar mass of agglomerated amino acid. Thus, the concentration of surfactant in the aqueous solution can be from 1%, by weight, to 6%, by weight, surfactant in the aqueous surfactant solution, although the process may be performed using a surfactant solution having a concentration of surfactant outside of this range. In certain embodiments, the surfactant solution can have a surfactant concentration of, for example, from 3%, by weight, to about 6%, by weight, such as, for example, 4%, by weight. The aqueous surfactant solution may be applied by any suitable method such as, for example, by spraying the surfactant solution onto the amino acid particles in a fluid bed, then agitating the mixture sufficiently to produce a thorough intermixture. An amino acid particle may be partially or completely coated by the food grade surfactant. Suitable food grade surfactants include those described above for coating agglomerated amino acid particles.

The surfactant-coated particles may be dried to reduce the water content resulting from the application of the aqueous surfactant solution, thereby producing particles having a core of amino acid and a shell of surfactant. The same drying conditions, processes (e.g., use of a fluid bed), and considerations may be used to dry the surfactant-coated amino acid particles as was described above to dry surfactant-coated agglomerates.

The surfactant-coated amino acid particles are suitable to form an instantized amino acid product. The instantized amino acid product may be added to a liquid to form an amino acid-enriched liquid. The amount of surfactant-coated amino acid particles that may be added to the liquid is the same as the amount of amino acid described above when using surfactant-coated agglomerated amino acids to produce an amino acid-enriched liquid.

In some embodiments, one or more ingredients may be added to the liquid in addition to the surfactant-coated amino acid particles. Such other ingredients include, for example, vitamins, minerals, nutritional supplements, sweeteners, thickening agents, and the like.

The second process embodiment of surfactant-coated amino acid particles works best with slightly larger and uniform particle size amino acid. If small particles (less than 200 microns) are obtained the preferred process is the first embodiment process using agglomerates. The second process embodiment of surfactant-coated particles has some advantages in that there is no gum used. The gum can form a small residue in the end product liquid. Also the surfactant-coated particles is a simpler process and involves fewer steps.

### EXEMPLARY EMBODIMENTS

### Embodiment 1

A process for producing an instantized amino acid product comprising:

obtaining a particulate amino acid;

coating the amino acid particles with an aqueous solution of a food grade gum;

adhering at least one gum-coated amino acid particle to at least one other gum-coated amino acid particle, thereby forming an agglomerate of amino acid particles;

drying the agglomerate;

coating the agglomerate with an aqueous solution of a food grade surfactant; and

drying the surfactant-coated agglomerate.

### Embodiment 2

The process of Embodiment 1 wherein the amino acid particles have a particle size diameter of from about 63 microns to about 400 microns

### Embodiment 3

The process of Embodiment 1 or Embodiment 2 wherein the amino acid particles have a particle size diameter of from about 100 microns to about 200 microns.

### Embodiment 4

The process of any one of Embodiments 1-3 wherein the food grade gum comprises guar gum.

### Embodiment 5

The process of any one of Embodiments 1-4 wherein the surfactant comprises soy lecithin or sunflower lecithin.

### Embodiment 6

The process of any one of Embodiments 1-5 wherein the amino acid is a branched chain amino acid.

### Embodiment 7

The process of any one of Embodiments 1-6 wherein the agglomerate is dried at a temperature of from about 140° F. to about 212° F.

### Embodiment 8

The process of Embodiment 7, wherein the drying occurs in a fluid bed apparatus.

### Embodiment 9

The process of any one of Embodiments 1-8 wherein the aqueous solution of the food grade gum comprises a gum concentration of from about 2%, by weight, to about 15%, by weight.

### Embodiment 10

The process of any one of Embodiments 1-9 wherein the aqueous solution of the food grade surfactant comprises a surfactant concentration of from about 1%, by weight to about 5%, by weight.

### Embodiment 11

The process of any one of Embodiments 1-10 wherein the amino acid particles are hammer milled or jet milled.

### Embodiment 12

A process for producing an instantized amino acid product comprising:

obtaining a particulate amino acid;

coating the outer surface of the amino acid particles with an aqueous solution of a food grade surfactant; and

drying the surfactant-coated amino acid particles.

### Embodiment 13

The process of Embodiment 12 wherein the amino acid particles have an average particle size diameter of from about 150 microns to about 400 microns.

### Embodiment 14

The process of Embodiment 12 or Embodiment 13 wherein the amino acid particles have an average particle size diameter of from about 200 microns to about 300 microns.

### Embodiment 15

The process of any one of Embodiments 12-14 wherein the amino acid comprises a branched chain amino acid.

### Embodiment 16

The process of any one of Embodiments 12-15 wherein the surfactant-coated amino acid particles are dried in a fluid bed apparatus at a temperature of from about 160° F. to about 180° F.

### Embodiment 17

An agglomerate comprising:

an inner core comprising:
at least two amino acid particles adhered to another with a food grade gum; and
at least one open porous channel between the amino acid particles; and an outer layer comprising a food grade surfactant.

### Embodiment 18

An amino acid-enriched beverage comprising a liquid and the instantized amino acid agglomerates of embodiment 17.

### Embodiment 19

The amino acid-enriched beverage of Embodiment 18 wherein the amino acid agglomerates are prepared by the method of Embodiment 1.

### Embodiment 20

The amino acid-enriched beverage of Embodiment 18 or Embodiment 19 wherein the beverage comprises from about 1 gram to about 10 grams of the instantized amino acid agglomerates per 200 milliliters of liquid.

### Embodiment 21

The amino acid-enriched beverage of any one of Embodiments 18-20 wherein the liquid comprises a milk product.

### Embodiment 22

An amino acid-enriched beverage comprising a liquid and instantized surfactant-coated amino acid particles prepared by the method of Embodiment 12.

As used herein, the term “and/or” means one or all of the listed elements or a combination of any two or more of the listed elements; the terms “comprises” and variations thereof do not have a limiting meaning where these terms appear in the description and claims; unless otherwise specified, “a,” “an,” “the,” and “at least one” are used interchangeably and mean one or more than one; and the recitations of numerical ranges by endpoints include all numbers subsumed within that range (e.g., 1 to 5 includes 1, 1.5, 2, 2.75, 3, 3.80, 4, 5, etc.).

In the preceding description, particular embodiments may be described in isolation for clarity. Unless otherwise expressly specified that the features of a particular embodiment are incompatible with the features of another embodiment, certain embodiments can include a combination of compatible features described herein in connection with one or more embodiments.

For any method disclosed herein that includes discrete steps, the steps may be conducted in any feasible order. And, as appropriate, any combination of two or more steps may be conducted simultaneously.

In the foregoing description, certain terms have been used for brevity, clarity and understanding, however, no unnecessary limitations are to be implied therefrom, because such terms are used for descriptive purposes and are intended to be broadly construed. Moreover, the descriptions and examples herein are by way of examples and the exemplary embodiment is not limited to the exact details shown and described.

Unless otherwise indicated, all numbers expressing quantities of components, molecular weights, and so forth used in the specification and claims are to be understood as being modified in all instances by the term “about.” Accordingly, unless otherwise indicated to the contrary, the numerical parameters set forth in the specification and claims are approximations that may vary depending upon the desired properties sought to be obtained by the present invention. At the very least, and not as an attempt to limit the doctrine of equivalents to the scope of the claims, each numerical parameter should at least be construed in light of the number of reported significant digits and by applying ordinary rounding techniques.

1. A process for producing an instantized amino acid product comprising:
obtaining a particulate amino acid;
coating the amino acid particles with an aqueous solution of a food grade gum;
adhering at least one gum-coated amino acid particle to at least one other gum-coated amino acid particle, thereby forming an agglomerate of amino acid particles;
drying the agglomerate;
coating the agglomerate with an aqueous solution of a food grade surfactant; and
drying the surfactant-coated agglomerate.

2. The process of claim 1 wherein the amino acid particles have a particle size diameter of from about 63 microns to about 400 microns.

3. The process of claim 1 wherein the amino acid particles have a particle size diameter of from about 100 microns to about 200 microns.

4. The process of claim 1 wherein the food grade gum comprises guar gum.

5. The process of claim 1 wherein the surfactant comprises soy lecithin or sunflower lecithin.

6. The process of claim 1 wherein the amino acid is a branched chain amino acid.

7. The process of claim 1 wherein the agglomerate is dried at a temperature of from about 140° F. to about 212° F.

8. The process of claim 7, wherein the drying occurs in a fluid bed apparatus,

9. The process of claim 1 wherein the aqueous solution of the food grade gum comprises a gum concentration of from about 2%, by weight, to about 15%, by weight.

10. The process of claim 1 wherein the aqueous solution of the food grade surfactant comprises a surfactant concentration of from about 1%, by weight to about 5%, by weight.

11. The process of claim 1 wherein the amino acid particles are hammer milled or jet milled.

12. A process for producing an instantized amino acid product comprising:
obtaining a particulate amino acid;
coating the outer surface of the amino acid particles with an aqueous solution of a food grade surfactant; and
drying the surfactant-coated amino acid particles.

13. The process of claim 12 wherein the amino acid particles have an average particle size diameter of from about 150 microns to about 400 microns.

14. The process of claim 12 wherein the amino acid particles have an average particle size diameter of from about 200 microns to about 300 microns.

15. The process of claim 12 wherein the amino acid comprises a branched chain amino acid.

16. The process of claim 12 wherein the surfactant-coated amino acid particles are dried in a fluid bed apparatus at a temperature of from about 140° F. to about 212° F.

17. An agglomerate comprising:
an inner core comprising:
at least two amino acid particles adhered to another with a food grade gum; and
open porous channels between the amino acid particles; and
an outer layer comprising a food grade surfactant.

18. An amino acid-enriched beverage comprising a liquid and the instantized amino acid agglomerates of claim 17.

19. The amino acid-enriched beverage of claim 18 wherein the amino acid agglomerates are prepared by a process comprising:
obtaining a particulate amino acid;
coating the amino acid particles with an aqueous solution of a food grade gum;
adhering at least one gum-coated amino acid particle to at least one other gum-coated amino acid particle, thereby forming an agglomerate of amino acid particles;
drying the agglomerate;
coating the agglomerate with an aqueous solution of a food grade surfactant; and
drying the surfactant-coated agglomerate.

20. The amino acid-enriched beverage of claim 18 wherein the beverage comprises from about 1 gram to about 10 grams of the instantized amino acid agglomerates per 200 milliliters of liquid.

21. The amino acid-enriched beverage of claim 18 wherein the liquid comprises a milk product.

22. An amino acid-enriched beverage comprising a liquid and instantized surfactant-coated amino acid particles prepared by a process comprising:
obtaining a particulate amino acid;
coating the outer surface of the amino acid particles with an aqueous solution of a food grade surfactant; and
drying the surfactant-coated amino acid particles.
